(19) United States
(12) Patent Application Publication
(10) Pub. No.: US 2013/0191839 A1
(43) Pub. Date: Jul. 25, 2013

(54) INFORMATION PROCESSING APPARATUS, CONTROL METHOD THEREFOR, AND COMPUTER-READABLE STORAGE MEDIUM

(71) Applicant: Canon Kabushiki Kaisha, Tokyo (JP)

(72) Inventor: Junichi Ishikawa, Kawasaki-shi (JP)

(73) Assignee: CANON KABUSHIKI KAISHA, Tokyo (JP)

(21) Appl. No.: 13/670,030

(22) Filed: Nov. 6, 2012

(30) Foreign Application Priority Data
Jan. 19, 2012 (JP) 2012-009429

(51) Int. Cl. G06F 9/50

(52) U.S. Cl. 718/104

(57) ABSTRACT

When a process starts using a resource, management information is stored. Management information includes, in association with one another, process identification information indicating the process, resource identification information indicating the resource to be used by the process, and processor identification information indicating a processor allocated to the process. When waking up the process, a processor that is associated to the process to wake up in the management information is allocated to the process to wake up.

### BACKGROUND OF THE INVENTION

1. Field of the Invention

The present invention relates to a multi-processor core system that executes parallel processing using a plurality of processor cores, and particularly to technology for selecting an execution processor core at the time of process wake-up.

2. Description of the Related Art

In recent years, information processing apparatuses commonly incorporate a multi-processor core system that executes parallel processing using a plurality of processor cores. This system includes a plurality of processes that execute parallel processing and selects which processor to use in executing each process using a scheduling function of an operating system (OS).

When a new process is generated, the OS preferentially allocates a processor that executes a parent process from which the new process has been generated to the new process. However, when a process is put to sleep, allocation of a processor to that process is removed. Upon wake-up of the sleeping process, a selection is made again as to which processor to use in executing that process. When waking up the sleeping process, the OS prioritizes execution using a processor that previously executed that process in consideration of the effectiveness of a memory cache. Note that when the loads on processors provided in the system is unbalanced, execution using another processor may be selected to balance the loads.

Japanese Patent Laid-Open No. 2010-128664 discloses a method for detecting a resource that triggers resource contention and avoiding the detected resource contention through scheduling in a multi-processor core system. More specifically, when a process that has woken up is involved in resource contention, based on a lock request to the resource and the wait time that follows the lock request, a processor corresponding to the wait time is selected from among a plurality of processors.

On the other hand, Japanese Patent Laid-Open No. 2009-48358 discloses a method for changing a scheduling scheme based on dependence relationships among processes. More specifically, processing from wake-up to sleep of a process that performs time-shared scheduling is treated as a node, and dependence relationships among nodes are analyzed. Based on information of the analyzed dependence relationships, a scheme that performs group scheduling in units of processes is newly used.

When there are a plurality of processes that execute parallel processing, they may communicate with one another using the same shared memory, or may read and write the same file. In such cases, these processes hold the same data in a cache memory. In view of a cache hit ratio and the processing time related to cache coherency, the efficiency is improved when these processes are included in the same processor.

However, upon process wake-up, a scheduling function of a conventional multi-processor core system selects a processor without consideration of a cache memory handled by a process. This gives rise to the problem that, even when a plurality of processes hold the same data in a cache memory, they operate in different processors.

Furthermore, the technology described in Japanese Patent Laid-Open No. 2010-128664 is problematic in that, although it can select a processor based on resource contention, it cannot select a processor in consideration of a cache memory.

Also, the technology described in Japanese Patent Laid-Open No. 2009-48358 is problematic in that, although it can change the scheduling based on dependence relationships among processes, it cannot select a processor based on the dependence relationships.

### SUMMARY OF THE INVENTION

The present invention provides technology for reducing the processing time of a process that has been woken up in a multi-processor core system that executes parallel processing using a plurality of processor cores.

In order to achieve the above aim, an information processing apparatus according to the present invention is provided with a plurality of processors and includes: a first control unit that stores management information when a process starts using a resource, the management information including, in association with one another, process identification information indicating the process, resource identification information indicating the resource to be used by the process, and processor identification information indicating a processor allocated to the process; and a second control unit that, when waking up the process, allocates a processor that is associated with the process to wake up in the management information to the process to wake up.

In a system that executes parallel processing using a plurality of processors, the present invention selects a processor upon wake-up of a process in consideration of a resource such as a memory area and a file that was handled by the process before the wake-up. This allows improving a cache hit ratio and reducing the processing time related to cache coherency.

Further features of the present invention will become apparent from the following description of exemplary embodiments (with reference to the attached drawings).

### BRIEF DESCRIPTION OF THE DRAWINGS

FIG. 1 shows a main configuration of an information processing apparatus according to the present invention.

FIG. 2 shows a usage example of an information processing apparatus according to Embodiment 1.

FIG. 3 shows a main configuration of the information processing apparatus according to Embodiment 1.

FIG. 4 shows a selection of a CPU in the information processing apparatus according to Embodiment 1.

FIG. 5 is a flowchart of processing for starting the use of a shared memory in Embodiment 1.

FIG. 6 shows examples of a shared memory access list according to Embodiment 1.

FIG. 7 is a flowchart of processing for putting a process to sleep in Embodiment 1.

FIG. 8 is a flowchart of processing for waking up a process in Embodiment 1.

FIG. 9 shows a main configuration of an information processing apparatus according to Embodiment 2.

FIG. 10 shows a selection of a CPU in the information processing apparatus according to Embodiment 2.

FIG. 11 is a flowchart of processing for starting the use of a file in Embodiment 2.

FIG. 12 shows examples of a file access list according to Embodiment 2.

FIG. 13 is a flowchart of processing for putting a process to sleep in Embodiment 2.

FIG. 14 is a flowchart of processing for waking up a process in Embodiment 2.

### DESCRIPTION OF THE EMBODIMENTS

The following is a detailed description of embodiments of the present invention with reference to the drawings.

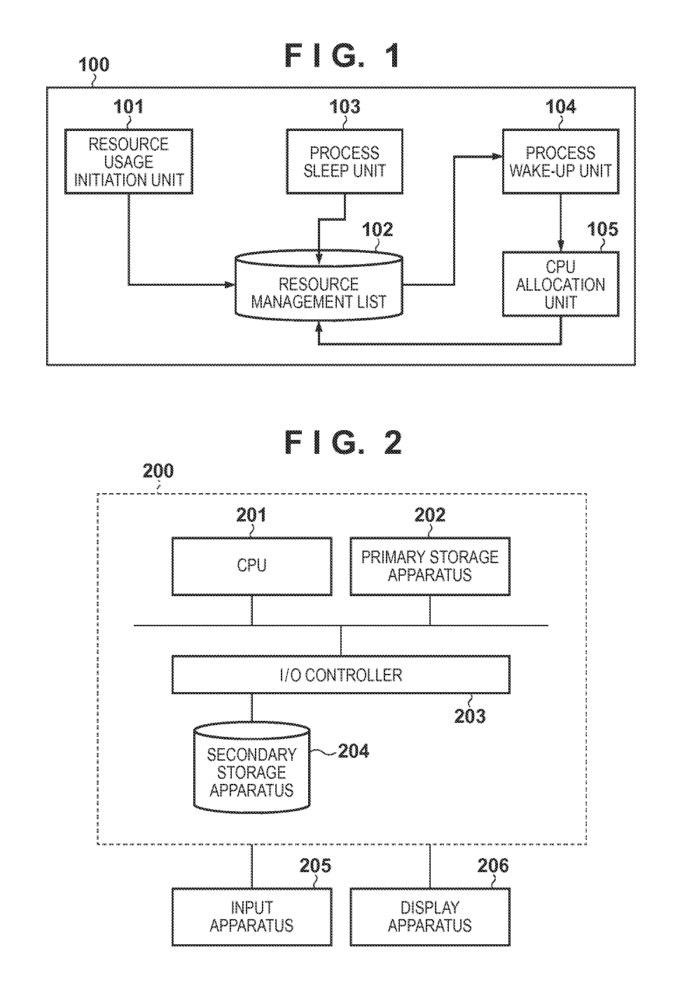

The present invention can be realized in many different embodiments. A description is now given of a basic configuration of an information processing apparatus according to the present invention with reference to FIG. 1.

In FIG. 1, 100 denotes a system (information processing apparatus) that executes parallel processing using a plurality of processors. In many cases, general multiprocessing uses a plurality of single-core CPUs or a multi-core CPU, and CPUs are considered synonymous with arithmetic processing chips. However, in the field of assembling technology, processor cores provided in a multi-core CPU are often referred to as CPU 0 through CPU n. In view of this, a processor is hereinafter referred to as a CPU. In the present description, it is assumed that a processor, a processor core and a coprocessor are substantially synonymous.

In FIG. 1, 101 denotes a resource usage initiation unit (first control unit) that is executed when a process starts using a certain resource (e.g. data, a file and a shared memory area). Execution of the resource usage initiation unit 101 by the process enables the use of the certain resource. The resource usage initiation unit 101 stores management information in a resource management list 102. The management information is a set of process identification information for identifying the process (hereinafter “process ID”), CPU identification information for identifying a CPU allocated to the process (synonymous with processor identification information; hereinafter “CPU ID”), and resource identification information for identifying the resource (hereinafter “resource ID”).

Also, 103 denotes a process sleep unit that is executed when putting a process to sleep. When a process executes the process sleep unit 103, allocation of a CPU to the target process is removed, and the target process is added to a wait queue and placed in a sleeping state. Then, the process sleep unit 103 searches the management information stored in the resource management list 102 for a process ID of the process that has been put to sleep, and changes the corresponding CPU ID in the management information to “no allocation” (clears the allocation).

Also, 104 denotes a process wake-up unit that is executed when waking up a process. Upon issuance of a wake-up instruction to a certain process, the process wake-up unit 104 determines whether or not the resource management list 102 includes a process ID of the certain process to wake up (first process ID) and a process ID of a process that uses the same resource as the certain process to wake up (second process ID). When the resource management list 102 includes these process IDs, the process wake-up unit 104 acquires, from the resource management list 102, a CPU ID allocated to the process that uses the same resource as the certain process to wake up.

A CPU allocation unit 105 (second control unit), which is executed after execution of the process wake-up unit 104, allocates a CPU to the certain process to wake up. When the process wake-up unit 104 has acquired the CPU ID, the CPU allocation unit 105 identifies a CPU corresponding to the acquired CPU ID and allocates that CPU to the certain process to wake up. On the other hand, when the process wake-up unit 104 has not acquired the CPU ID, the CPU allocation unit 105 identifies an execution CPU using a CPU identification unit of the OS and allocates the identified CPU to the certain process to wake up. Note that a CPU identification function of the OS comes in a wide variety of types. Examples include a method whereby the CPU 0 through the CPU n are allocated in order from the smallest ID, and a method whereby a CPU with the smallest load is preferentially allocated.

After the CPU is allocated, the CPU allocation unit 105 moves the certain process to wake up from the wait queue to the allocated CPU, and changes (updates) the state of the process to an executable state. Then, the CPU allocation unit 105 searches the management information in the resource management list 102 for a process ID of the certain process to wake up, and changes the corresponding CPU ID in the management information to the identified CPU ID.

This concludes the description of the basic configuration of the information processing apparatus according to the present invention. Although the details of a resource to be used are not discussed above with reference to FIG. 1, the following embodiments describe a main configuration and a processing procedure (control method) of an information processing apparatus according to the present invention using a specific resource (e.g. a shared memory and data such as a file).

### Embodiment 1

The following is a detailed description of Embodiment 1 of the present invention with reference to the drawings.

Embodiment 1 provides a description of a configuration for selecting a CPU based on information of a shared memory (a memory area that can be shared among a plurality of processes) as a resource.

FIG. 2 shows a usage example of an information processing apparatus to which the present invention can be applied. In FIG. 2, 200 denotes an information processing apparatus, 201 denotes a CPU, 202 denotes a primary storage apparatus, 203 denotes an I/O controller, 204 denotes a secondary storage apparatus, 205 denotes an input apparatus, and 206 denotes a display apparatus. Normally, in the information processing apparatus 200, the CPU 201 processes a plurality of processes one by one while switching between the plurality of processes at a certain interval. The CPU 201 includes one or more processor cores that execute arithmetic processing and the like. There may be cases where a plurality of CPUs 201 are provided in the information processing apparatus 200.

The primary storage apparatus 202 stores programs and data. A shared memory area that can be accessed by a plurality of processes simultaneously in parallel is secured in the primary storage apparatus 202. Data such as files and directories is stored in the secondary storage apparatus 204. The data in the secondary storage apparatus 204 can be operated by an operating system issuing a read request and a write request to the I/O controller 203.

The input apparatus 205 is composed of a keyboard and a pointing device (e.g. a mouse), and receives operational instructions from a user. The display apparatus 206 displays a GUI (e.g. a cursor and a window) for operating the information processing apparatus 200.

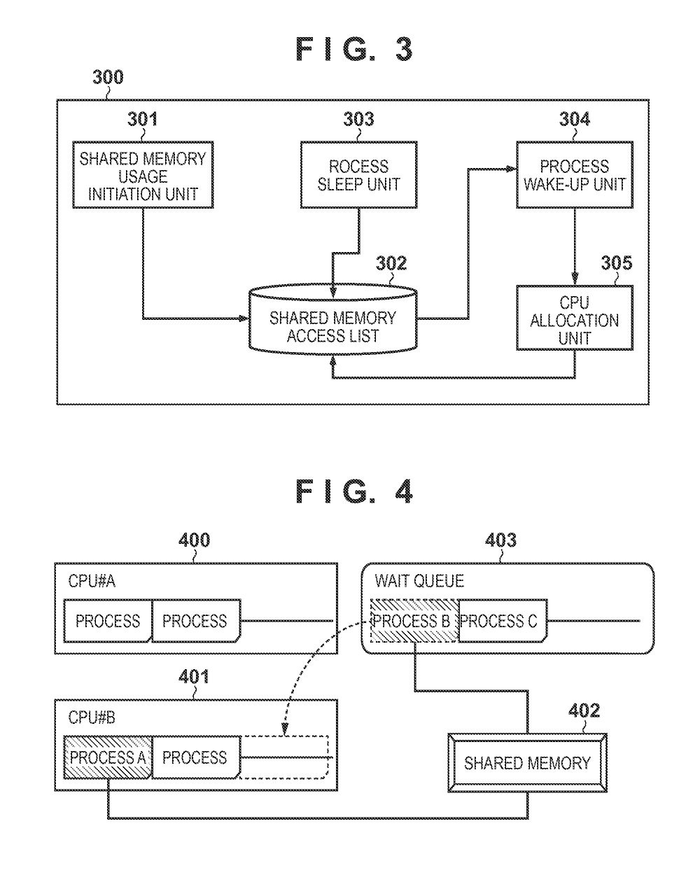

FIG. 3 shows a main configuration of an information processing apparatus according to Embodiment 1. In FIG. 3, 300 is equivalent to the system 100 of FIG. 1, and therefore a description thereof is omitted.

In FIG. 3, 301 denotes a shared memory usage initiation unit that is executed when starting the use of a shared memory that can be accessed by a plurality of processes simultaneously in parallel. When a process executes the shared memory usage initiation unit 301 with a designation of a shared memory ID that identifies the shared memory, the designated shared memory is mapped to a data segment of the process. The shared memory usage initiation unit 301 stores, in a shared memory access list 302, management information composed of a set of a process ID, a CPU ID of a CPU allocated to the process, and the shared memory ID of the mapped shared memory. The shared memory access list 302 is in the primary storage apparatus 202 or the secondary storage apparatus 204.

Also, 303 denotes a process sleep unit that is executed when putting a process to sleep. When a process executes the process sleep unit 303, allocation of a CPU to the target process is removed, and the target process is added to a wait queue and placed in a sleeping state. Then, the process sleep unit 303 searches the management information in the shared memory access list 302 for a process ID of the process that has been put to sleep, and changes the corresponding CPU ID in the management information to “no allocation”.

Also, 304 denotes a process wake-up unit that is executed when waking up a process. Upon issuance of a wake-up instruction to a certain process, the process wake-up unit 304 determines whether or not the shared memory access list 302 includes a process ID of the certain process to wake up and a process ID of a process that uses the same shared memory as the certain process to wake up. When the shared memory access list 302 includes these process IDs, the process wake-up unit 304 acquires, from the shared memory access list 302, a CPU ID allocated to the process that uses the same shared memory as the certain process to wake up. Whether or not the same shared memory is used may be determined using various methods. For example, in the case where sharable memory areas are assigned area IDs, whether or not the same shared memory is used may be determined based on the area IDs. Alternatively, whether or not the same shared memory is used may be determined based on continuity of addresses and information unique to memory chips (chip IDs and parts of addresses).

A CPU allocation unit 305, which is executed after execution of the process wake-up unit 304, allocates a CPU to the certain process to wake up. CPU allocation and moving of the process are the same as the case of the CPU allocation unit 105 described with reference to FIG. 1, and therefore a description thereof is omitted. After moving the process, the CPU allocation unit 305 searches the management information in the shared memory access list 302 for a process ID of the certain process to wake up, and changes the corresponding CPU ID in the management information to the identified CPU ID.

FIG. 4 illustrates a selection of a CPU in the configuration of FIG. 3 based on whether or not a plurality of processes use the same shared memory in the case of a system provided with two CPUs.

In FIG. 4, 400 denotes a first CPU #A which includes a plurality of processes. Also, 401 denotes a second CPU #B which includes a plurality of processes. Out of these processes, a process A uses a shared memory 402. Also, 403 denotes a wait queue including a process B that uses the shared memory 402 and a process C that does not use the shared memory 402.

When the process B in the wait queue 403 is woken up in this state, the process B is moved to the second CPU #B 401 as it uses the same shared memory 402 as the process A, and the state of the process B is changed to an executable state.

When the process C in the wait queue 403 is woken up, a CPU identification unit of the OS moves the process C to the first CPU #A 400 or the second CPU #B 401 as the process C does not use the shared memory 402. Thereafter, the state of the process C is changed to an executable state in the CPU to which the process C has been moved.

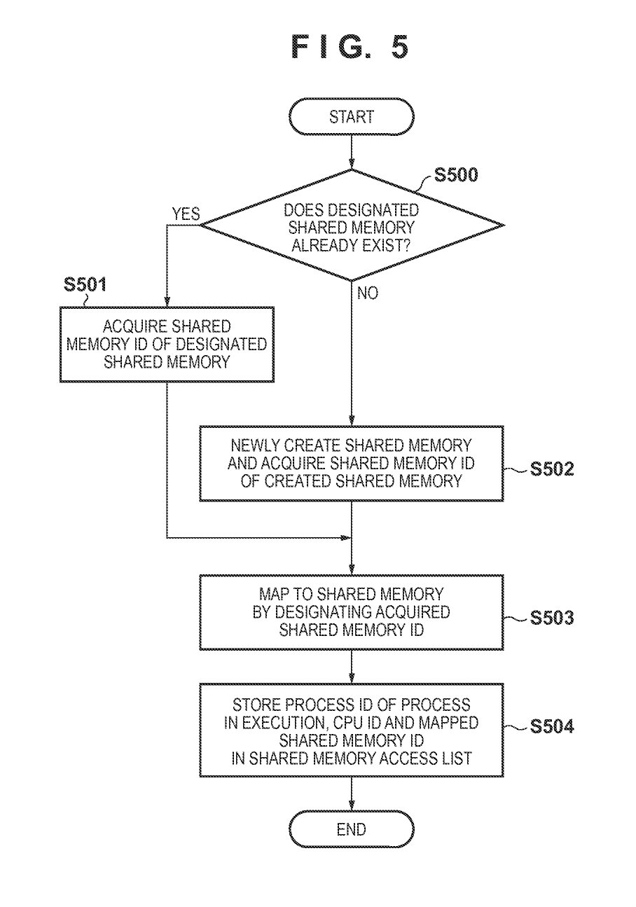

With reference to FIGS. 5, 6, 7 and 8, the following describes processing procedures for the case where the user uses an information processing apparatus with a system to which Embodiment 1 can be applied.

First, a description is given of a processing procedure for starting the use of a shared memory with reference to FIG. 5.

In step S500, the shared memory usage initiation unit 301 determines whether or not a shared memory designated by a process already exists. When the shared memory designated by the process exists (the YES branch of step S500), the processing moves to step S501 in which the shared memory usage initiation unit 301 acquires a shared memory ID of the shared memory designated by the process. On the other hand, when the shared memory designated by the process does not exist (the NO branch of step S500), the processing moves to step S502 in which the shared memory usage initiation unit 301 newly creates a shared memory in an area of the primary storage apparatus 202 and acquires a shared memory ID of the created shared memory.

In step S503, the shared memory usage initiation unit 301 maps the process that is to start using the shared memory to the shared memory by designating the acquired shared memory ID. In step S504, the shared memory usage initiation unit 301 stores, in the shared memory access list 302, management information composed of a set of a process ID of the process that has started using the shared memory, a CPU ID of a CPU including the process in execution, and the acquired shared memory ID.

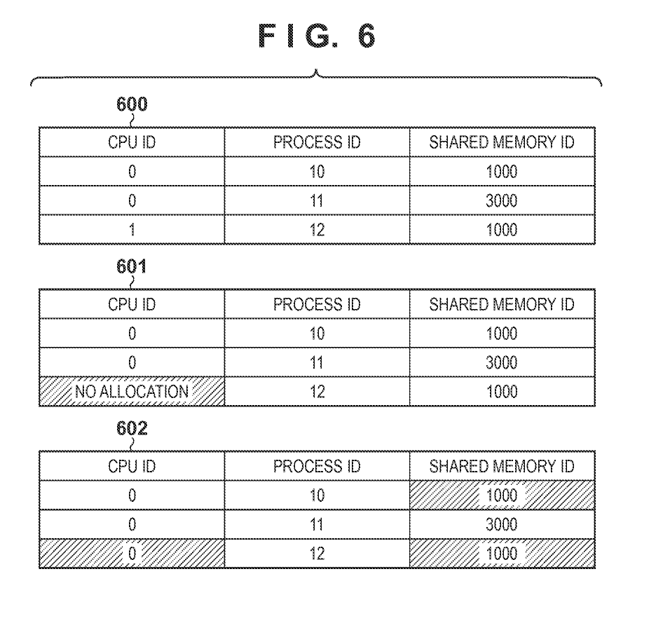

Below is a specific description of the shared memory access list 302 with reference to FIG. 6.

FIG. 6 shows specific examples of a shared memory access list. In FIG. 6, 600 denotes the shared memory access list in which the management information is stored in step S504. In the example of 600, a process ID “10” with a CPU ID “0” uses a shared memory “1000”. A process ID “11” with a CPU ID “0” uses a shared memory “3000”. A process ID “12” with a CPU ID “1” uses the shared memory “1000”. Each time a new shared memory is mapped, information is added to the shared memory access list 302.

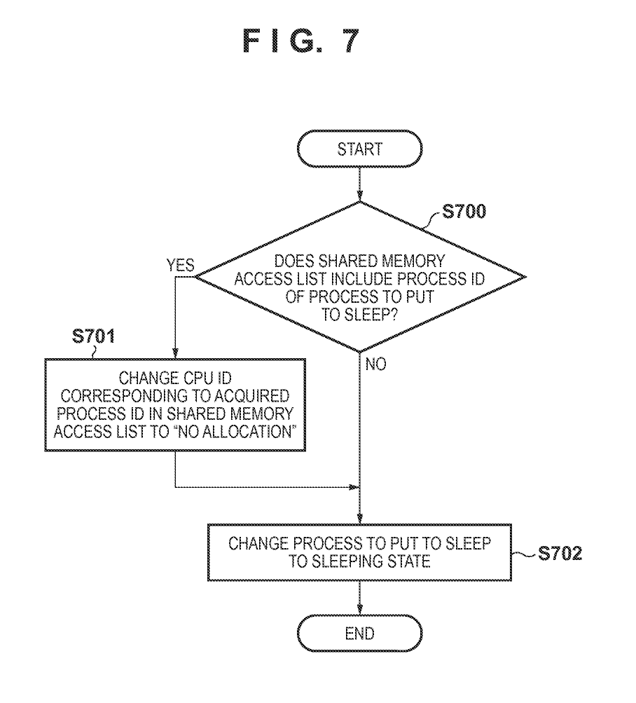

Next, a description is given of a procedure for putting a process to sleep with reference to FIG. 7.

In step S700, the process sleep unit 303 acquires a process ID of a process to put to sleep, and determines whether or not the shared memory access list 302 includes the acquired process ID. When the shared memory access list 302 includes the acquired process ID (the YES branch of step S700), the processing moves to step S701 in which the process sleep unit 303 changes a CPU ID corresponding to the acquired process ID to “no allocation”. On the other hand, when the shared memory access list 302 does not include the acquired process ID (the NO branch of step S700), the processing moves to step S702 in which the process sleep unit 303 moves the process to put to sleep from a CPU to a wait queue, thus placing it in a sleeping state.

Below is a specific description of the processes of steps S700 through S702 with reference to FIG. 6. In FIG. 6, 600 shows the state of the shared memory access list 302 after the process of step S504 of FIG. 5. When the shared memory access list 302 is in this state 600, the process with the process ID “12” is put to sleep. In this case, as information of the process ID “12” exists, the corresponding CPU ID is changed to “no allocation”. As a result, the shared memory access list 302 is placed in the state of 601 shown in FIG. 6.

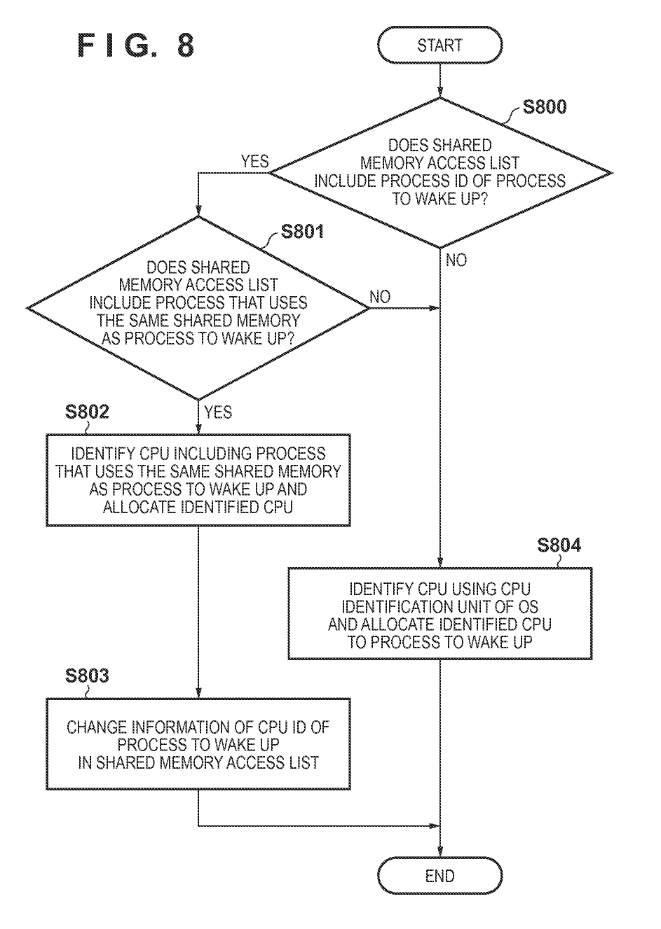

Next, a description is given of a procedure for waking up a sleeping process with reference to FIG. 8.

In step S800, the process wake-up unit 304 acquires a process ID of a process to wake up. Then, the process wake-up unit 304 refers to the shared memory access list 302 and determines whether or not the shared memory access list 302 includes the acquired process ID.

When the shared memory access list 302 does not include the acquired process ID (the NO branch of step S800), the processing moves to step S804 in which the process wake-up unit 304 identifies a CPU using the CPU identification unit of the OS. Thereafter, the CPU allocation unit 305 moves the process to wake up from a wait queue to the identified CPU and changes the state of the process to wake up to an executable state.

On the other hand, when the shared memory access list 302 includes the acquired process ID (the YES branch of step S800), the processing moves to step S801. In step S801, the process wake-up unit 304 refers to the shared memory access list 302, identifies a shared memory ID used by the acquired process ID, and determines whether or not another process that uses the identified shared memory ID exists.

When such a process does not exist (the NO branch of step S801), the processing moves to step S804. On the other hand, when such a process exists (the YES branch of step S801), the processing moves to step S802 in which the process wake-up unit 304 identifies a CPU including the process that uses the same shared memory as the process to wake up. Thereafter, the CPU allocation unit 105 moves the process to wake up from a wait queue to the identified CPU and changes the state of the process to wake up to an executable state.

In step S803, the process wake-up unit 304 changes a CPU ID corresponding to the process to wake up in the shared memory access list 302 to the CPU ID identified in step S802.

Below is a specific description of the processes of steps S800 through S803 with reference to FIG. 6. In FIG. 6, 601 shows the state of the shared memory access list 302 changed after placing the process in a sleeping state in step S701 of FIG. 7. When the shared memory access list 302 is in this state 601, the process with the process ID “12” is woken up. In this case, as information of the process ID “12” exists, a shared memory ID corresponding to the process ID “12” is referred to. The shared memory ID is “1000”, and another process that uses the shared memory ID “1000”, namely the process with the process ID “10”, exists. As the process ID “10” corresponds to the CPU ID “0”, the CPU ID corresponding to the process ID “12” of the process to wake up is changed from “no allocation” to “0”. As a result, the shared memory access list 302 is placed in the state of 602 shown in FIG. 6.

As set forth above, in Embodiment 1, when a process executes the shared memory usage initiation unit 301 to start using a shared memory, information thereof is added to the shared memory access list 302. When a process executes the process sleep unit 303 to put a process to sleep, the shared memory access list 302 is changed based on information of that process. When a process executes the process wake-up unit 304 to wake up a certain process, information of that process in the shared memory access list 302 is referred to. The CPU allocation unit 305 allocates a CPU based on the information referred to, and the shared memory access list 302 is changed based on the result of the allocation.

In this way, a process that handles a shared memory wakes up in a CPU including another process that handles the same shared memory. As a result, the processing time required for maintaining cache coherency can be reduced, a cache hit ratio can be improved, and therefore the processing time of a process that has been woken up can be reduced.

### Embodiment 2

The following is a detailed description of Embodiment 2 of the present invention with reference to the drawings.

Embodiment 2 provides a description of a configuration for selecting a CPU based on information of a file, which is one type of resources. In this point, Embodiment 2 differs from Embodiment 1.

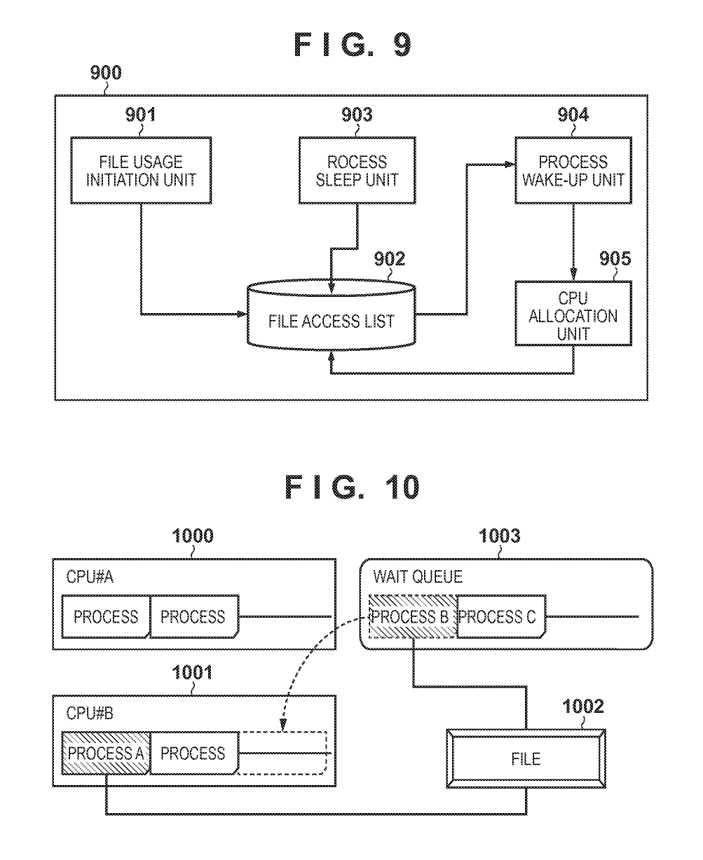

FIG. 9 shows a usage example of an information processing apparatus to which the present invention can be applied. In FIG. 9, 900 is equivalent to the system 100 of FIG. 1, and therefore a description thereof is omitted.

In FIG. 9, 901 denotes a file usage initiation unit that is executed when starting the use of a file. When a process executes the file usage initiation unit 901 with a designation of a file name, a file with that file name is opened, and the process acquires a file ID of the opened file. The file usage initiation unit 901 stores, in a file access list 902, management information composed of a set of a process ID, a CPU ID of a CPU allocated to the process, and the file ID of the opened file. The file access list 902 is in the primary storage apparatus 202 or the secondary storage apparatus 204.

Also, 903 denotes a process sleep unit that is executed when putting a process to sleep. When a process executes the process sleep unit 903, allocation of a CPU to the target process is removed, and the target process is added to a wait queue and placed in a sleeping state. Then, the process sleep unit 903 searches the management information in the file access list 902 for a process ID of the process that has been put to sleep, and changes the corresponding CPU ID in the management information to “no allocation”.

Also, 904 denotes a process wake-up unit that is executed when waking up a process. Upon issuance of a wake-up instruction to a certain process, the process wake-up unit 904 determines whether or not the file access list 902 includes a process ID of the certain process to wake up and a process ID of a process that uses the same file as the certain process to wake up. When the file access list 902 includes these process IDs, the process wake-up unit 904 acquires a CPU ID allocated to the process that uses the same file as the certain process to wake up.

A CPU allocation unit 905, which is executed after execution of the process wake-up unit 904, allocates a CPU to the certain process to wake up and moves the certain process to wake up. CPU allocation and moving of the process are the same as the case of the CPU allocation unit 105 described with reference to FIG. 1, and therefore a description thereof is omitted. After moving the process, the CPU allocation unit 905 searches the management information in the file access list 902 for a process ID of the certain process to wake up, and changes the corresponding CPU ID in the management information to the identified CPU ID.

FIG. 10 illustrates a selection of a CPU in the configuration of FIG. 9 based on whether or not a plurality of processes access the same file in the case of a system provided with two CPUs. Note that 1000, 1001 and 1003 in FIG. 10 are the same as the CPU #A 400, the CPU #B 401 and the wait queue 403 of FIG. 4, respectively, and therefore a description thereof is omitted. FIG. 10 differs from FIG. 4 in including a file 1002.

The file 1002 is accessed only by a process A in the CPU #B 1001 and a process B in the wait queue 1003. When the process B in the wait queue 1003 is woken up in this state, the process B is moved to the second CPU #B 1001 as it accesses the same file 1002 as the process A, and the state of the process B is changed to an executable state.

On the other hand, when a process C in the wait queue 1003 is woken up, a CPU identification unit of the OS moves the process C to the first CPU #A 1000 or the second CPU #B 1001 as the process C does not access the file 1002. Thereafter, the state of the process C is changed to an executable state in the CPU to which the process C has been moved.

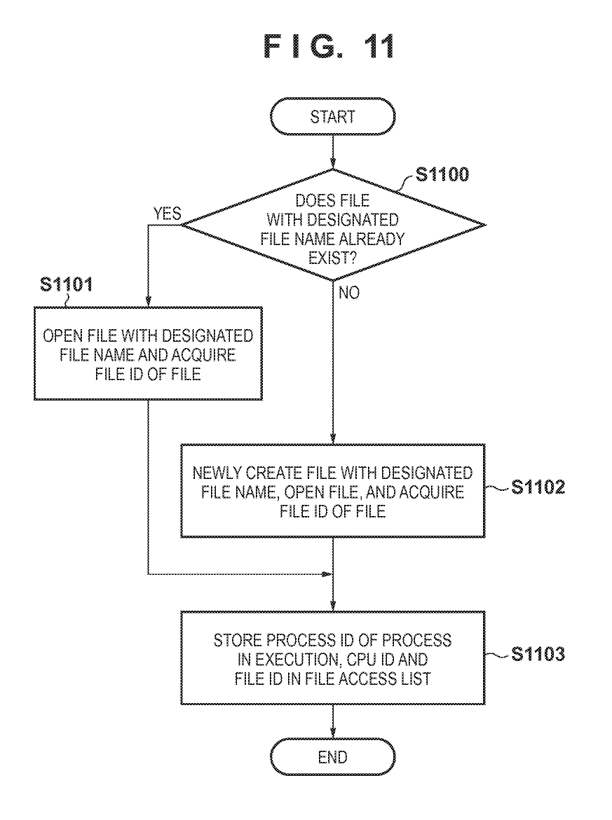

With reference to FIGS. 11, 12, 13 and 14, the following describes processing procedures for the case where the user uses an information processing apparatus with a system to which Embodiment 2 can be applied.

First, a description is given of a processing procedure for starting the use of a file with reference to FIG. 11.

In step S1100, the file usage initiation unit 901 determines whether or not a file with a file name designated by a process already exists. When the file with the designated file name exists (the YES branch of step S1100), the processing moves to step S1101 in which the file usage initiation unit 901 opens the file with the designated file name and acquires a file ID of the opened file. On the other hand, when the file with the designated file name does not exist (the NO branch of step S1100), the processing moves to step S1102 in which the file usage initiation unit 901 creates a file with the file name designated by the process in an area of the primary storage apparatus 202 or the secondary storage apparatus 204 and opens the created file. The file usage initiation unit 901 then acquires a file ID of the opened file.

In step S1103, the file usage initiation unit 901 stores, in the file access list 902, management information composed of a set of a process ID of the process in execution, a CPU ID of a CPU including the process in execution, and the file ID of the opened file.

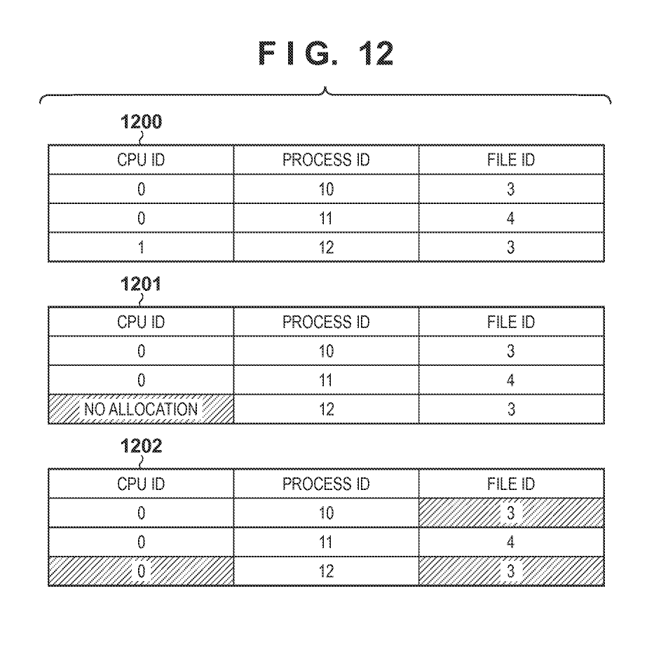

Below is a specific description of the file access list 902 with reference to FIG. 12.

FIG. 12 shows specific examples of a file access list. In FIG. 12, 1200 denotes the file access list 902 in which the management information is stored in step S1103. In the example of 1200, a process ID “10” with a CPU ID “0” uses a file ID “3”. A process ID “11” with a CPU ID “0” uses a file ID “4”. A process ID “12” with a CPU ID “1” uses a file ID “3”. Each time a new file is opened, information is added to the file access list 902.

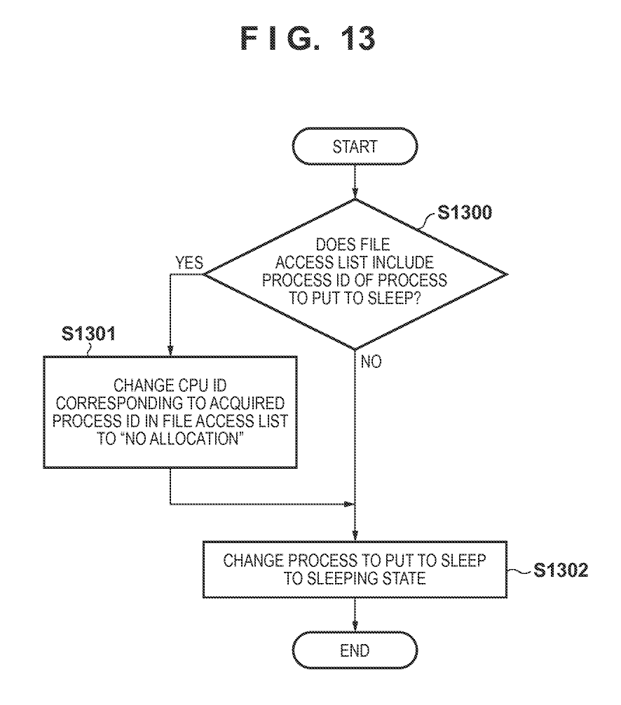

Next, a description is given of a procedure for putting a process to sleep with reference to FIG. 13.

In step S1300, the process sleep unit 903 acquires a process ID of a process to put to sleep and determines whether or not the file access list 902 includes the acquired process ID. When the file access list 902 includes the acquired process ID (the YES branch of step S1300), the processing moves to step S1301 in which the process sleep unit 903 changes a CPU ID corresponding to the acquired process ID to “no allocation”. On the other hand, when the file access list 902 does not include the acquired process ID (the NO branch of step S1300), the processing moves to step S1302 in which the process sleep unit 903 moves the process to put to sleep from a CPU to a wait queue, thus placing it in a sleeping state.

Below is a specific description of the processes of steps S1300 through S1302 with reference to FIG. 12. In FIG. 12, 1200 shows the state of the file access list 902 after the process of step S1103 in FIG. 11. When the file access list 902 is in this state 1200, the process with the process ID “12” is put to sleep. In this case, as information of the process ID “12” exists, the corresponding CPU ID is changed to “no allocation”. As a result, the file access list 902 is placed in the state of 1201 shown in FIG. 12.

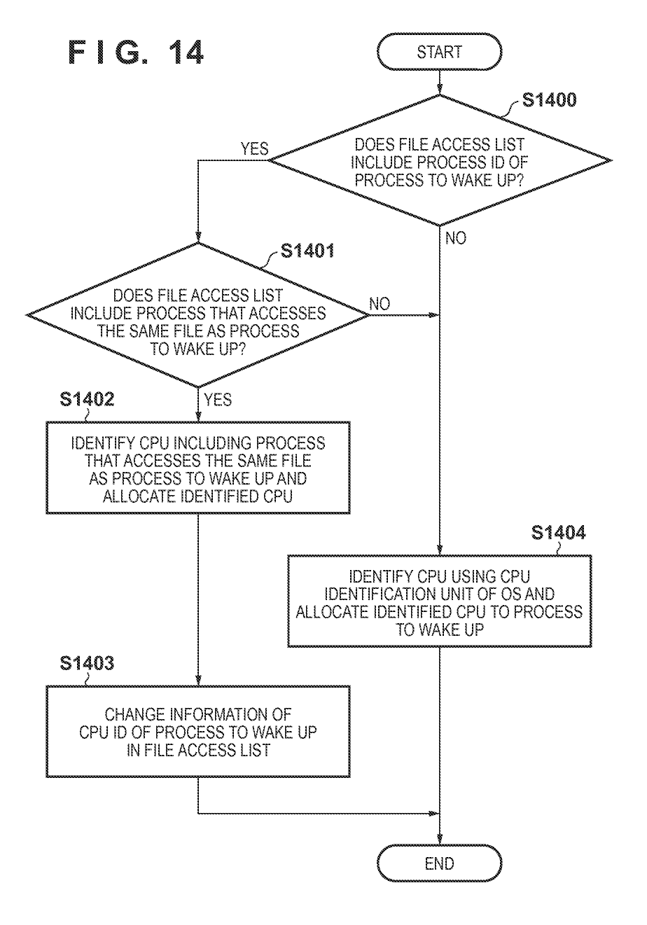

Next, a description is given of a procedure for waking up a sleeping process with reference to FIG. 14.

In step S1400, the process wake-up unit 904 acquires a process ID of a process to wake up. Then, the process wake-up unit 904 refers to the file access list 902 and determines whether or not the file access list 902 includes the acquired process ID.

When the file access list 902 does not include the acquired process ID (the NO branch of step S1400), the processing moves to step S1404 in which the process wake-up unit 904 identifies a CPU using the CPU identification unit of the OS. Thereafter, the CPU allocation unit 905 moves the process to wake up from a wait queue to the identified CPU and changes the state of the process to wake up to an executable state.

On the other hand, when the file access list 902 includes the acquired process ID (the YES branch of step S1400), the processing moves to step S1401. In step S1401, the process wake-up unit 904 refers to the file access list 902, identifies a file ID used by the acquired process ID, and determines whether or not another process that uses the identified file ID exists.

When such a process does not exist (the NO branch of step S1401), the processing moves to step S1404. On the other hand, when such a process exists (the YES branch of step S1401), the processing moves to step S1402 in which the process wake-up unit 904 identifies a CPU including the process that accesses the same file as the process to wake up. Thereafter, the CPU allocation unit 905 moves the process to wake up from a wait queue to the identified CPU and changes the state of the process to wake up to an executable state.

In step S1403, the process wake-up unit 904 changes a CPU ID corresponding to the process to wake up in the file access list 902 to the CPU ID identified in step S1402.

Below is a specific description of the processes of steps S1400 through S1403 with reference to FIG. 12. In FIG. 12, 1201 shows the state of the file access list 902 changed after placing the process in a sleeping state in step S1301 of FIG. 13. When the file access list 902 is in this state 1201, the process with the process ID “12” is woken up. In this case, as information of the process ID “12” exists, a file ID corresponding to the process ID “12” is referred to. The file ID is “3”, and another process that uses the file ID “3”, namely a process ID “10”, exists. As the process ID “10” corresponds to the CPU ID “0”, the CPU ID corresponding to the process ID “12” of the process to wake up is changed from “no allocation” to “0”. As a result, the file access list 902 is placed in the state of 1202 shown in FIG. 12.

As set forth above, in Embodiment 2, when a process executes the file usage initiation unit 901 to start using a file, information thereof is added to the file access list 902. When a process executes the process sleep unit 903 to put a process to sleep, the file access list 902 is changed based on information thereof. When a process executes the process wake-up unit 904 to wake up a certain process, information of that process in the file access list 902 is referred to. The CPU allocation unit 905 allocates a CPU based on the information referred to, and the file access list 902 is changed based on the result of the allocation.

In this way, a process that handles a file wakes up in a CPU including another process that handles the same file. By handling the same file in the same CPU, a primary cache hit ratio can be improved, and therefore the processing time of a process that has been woken up can be reduced.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-009429, filed on Jan. 19, 2012 which is hereby incorporated by reference herein in its entirety.

What is claimed is:

1. An information processing apparatus provided with a plurality of processors, comprising:
a first control unit configured to store management information when a process starts using a resource, the management information including, in association with one another, process identification information indicating the process, resource identification information indicating the resource to be used by the process, and processor identification information indicating a processor allocated to the process; and
a second control unit configured to, when waking up the process, allocate a processor that is associated with the process to wake up in the management information to the process to wake up.

2. The information processing apparatus according to claim 1, wherein
when the management information includes process identification information indicating a first process which is a process to wake up and process identification information indicating a second process that uses a resource used by the first process, the second control unit allocates a processor that is associated with the process identification information indicating the second process to the first process.

3. The information processing apparatus according to claim 1, wherein
when the management information includes process identification information indicating a first process which is a process to wake up and does not include process identification information indicating a second process that uses a resource used by the first process, the second control unit allocates a processor identified by an operating system (OS) to the first process.

4. The information processing apparatus according to claim 1, wherein
when the management information does not include process identification information indicating the process to wake up, the second control unit allocates a processor identified by an operating system (OS) to the process to wake up.

5. The information processing apparatus according to claim 1, further comprising
a process sleep unit configured to, when the process is put to sleep, update the management information including the process identification information indicating the process.

6. The information processing apparatus according to claim 5, wherein
when the management information includes the process identification information indicating the process to put to sleep, the process sleep unit clears the processor identification information associated with the process identification information.

7. The information processing apparatus according to claim 1, wherein
the resource is a shared memory.

8. The information processing apparatus according to claim 1, wherein
the resource is a file.

9. A control method for an information processing apparatus provided with a plurality of processors, comprising:
a first control step of storing management information when a process starts using a resource, the management information including, in association with one another, process identification information indicating the process, resource identification information indicating the resource to be used by the process, and processor identification information indicating a processor allocated to the process; and
a second control step of, when waking up the process, allocating a processor that is associated with the process to wake up in the management information to the process to wake up.

10. A computer-readable storage medium storing a program to be executed by an information processing apparatus provided with a plurality of processors, the program causing the information processing apparatus to function as:
a first control unit configured to store management information when a process starts using a resource, the management information including, in association with one another, process identification information indicating the process, resource identification information indicating the resource to be used by the process, and processor identification information indicating a processor allocated to the process; and
a second control unit configured to, when waking up the process, allocate a processor that is associated with the process to wake up in the management information to the process to wake up.
